(19) United States
(12) Patent Application Publication
(10) Pub. No.: US 2023/0310956 A1
(43) Pub. Date: Oct. 5, 2023

(54) SYSTEM AND METHOD FOR RATING GOLF COURSES

(71) Applicant: Benjamin Ticknor, Chestnut Hill, MA (US)

(72) Inventor: Benjamin Ticknor, Chestnut Hill, MA (US)

(21) Appl. No.: 18/128,667

(22) Filed: Mar. 30, 2023

Related U.S. Application Data
(60) Provisional application No. 63/325,348, filed on Mar. 30, 2022.

(51) Int. Cl. A63B 57/00; A63B 71/06

(52) U.S. Cl. CPC A63B 57/00; A63B 71/06

(57) ABSTRACT

An improved computerized application for determining difficulty ratings assigned to golf courses as part of the golf handicapping system, which is in contrast to the current method that is manual (i.e., requires human input and determination) and highly subjective. The illustrated embodiments of the present disclosure automatically updates golf course difficulty ratings by utilizing data from both initially assigned golf course values and from actual golfer scores. More specifically, the illustrated embodiments of the present disclosure provide an automated computer application utilizing machine learning techniques to determine difficulty ratings that are assigned to a given course using an iterative process contingent upon individual golfer score data. Thus, a more precise course ratings computer application is provided that increases the accuracy of a golf course rating over time as more data regarding actual golfer scores on that course is received.

### CROSS REFERENCE TO RELATED APPLICATIONS

This application claims priority to U.S. Pat. Application Serial No. 63/325,348 filed Mar. 30, 2022, which is incorporated herein by reference in its entirety.

### BACKGROUND

### 1. Field

The disclosed embodiments generally relate to evaluating golf course difficulty ratings, and more particularly, to dynamically evaluating golf course difficulty ratings utilizing golf score data.

### 2. Description of Related Art

Currently, rating a difficulty level of golf course (used to determine an a golfer’s handicap score) has been highly subjective and arbitrary as it relies upon an individual’s subjective opinion regarding a difficulty level of a golf course based upon the individual’s physical inspection of the golf course. The difficulty rating of a golf course is important (amongst other reasons) because it used heavily in determining a golfer’s handicap value.

It is to be appreciated that for years, a golfer’s handicap has been used to indicate an individual’s ability to play golf based on tee box location of a particular golf course. For example, the United States Golf Association (USGA) developed a handicap system (i.e., the USGA Handicap System™) that allows individuals to compete with each other on any golf course, regardless of their skill level, by providing a type of normalized golf score. In particular, the USGA’s handicap formula is made up of a series of calculations, which take into account for instance an individual’s handicap based on multiple factors such as an Equitable Stroke Control Score (or the adjusted gross score), a Course Rating, a Slope Rating, and the average value of all Slope Ratings.

Specifically, the United States Golf Association (USGA) currently utilizes a computer system known as the Golf Handicap Information Network (GHIN) to assign normalized ability scores to individual golfers. This system works by using a pair of real valued difficulty ratings assigned to a golf course to map golfers’ scores at that course into a normalized space.

The difficulty ratings associated with golf courses are infrequently assigned by an arbitrary process, and are not evaluated for accuracy. Specifically, the current system requires employees of the USGA (or associated organizations) to physically visit a golf course to make subjective determinations as to what appropriate values of the course difficulty ratings should be. Accordingly, thus is highly disadvantageous as these ratings are static (they change infrequently) and are not evaluated for accuracy in any way.

It is to be further appreciated that golf course raters are currently confronted with a difficult task in determining how difficult a given course is for a golfer of any skill level. This is particularly difficult since raters are required to make this determination without using golfer score data, as they have to rate new and altered courses before golfers have a chance to play them. Currently, there is no procedure to evaluate whether a golf course is inaccurately rated, nor a procedure to update golf course ratings.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

The illustrated embodiments of the present disclosure provide an improved computerized application for determining difficulty ratings assigned to golf courses as part of the golf handicapping system, which is in contrast to the current method that is manual (i.e., requires human input and determination) and highly subjective. The illustrated embodiments of the present disclosure automatically updates golf course difficulty ratings by utilizing data from both initially assigned golf course values and from actual golfer scores. More specifically, the illustrated embodiments of the present disclosure provide an automated computer application utilizing machine learning techniques to determine difficulty ratings that are assigned to a given course using an iterative process contingent upon individual golfer score data. Thus, a more precise course ratings computer application is provided that increases the accuracy of a golf course rating over time as more data regarding actual golfer scores on that course is received.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates a system overview and data-flow according to an embodiment of system operation;

FIG. 2 illustrates an example network device/node according to an embodiment of system operation; and

FIGS. 3 and 4 illustrate flowcharts depicting an exemplary method of operation according to an embodiment of the present disclosure.

### DETAILED DESCRIPTION OF CERTAIN EMBODIMENTS

Aspects of the disclosed embodiments are shown in the following description and related drawings directed to specific illustrated embodiments. Alternate preferred embodiments may be devised without departing from the scope of the illustrated. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action. Where a range of values is provided, it is understood that each intervening value, to the tenth of the unit of the lower limit unless the context clearly dictates otherwise, between the upper and lower limit of that range and any other stated or intervening value in that stated range is encompassed within the illustrated embodiments. The upper and lower limits of these smaller ranges may independently be included in the smaller ranges is also encompassed within the illustrated embodiments, subject to any specifically excluded limit in the stated range. Where the stated range includes one or both of the limits, ranges excluding either both of those included limits are also included in the illustrated embodiments.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above.

One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

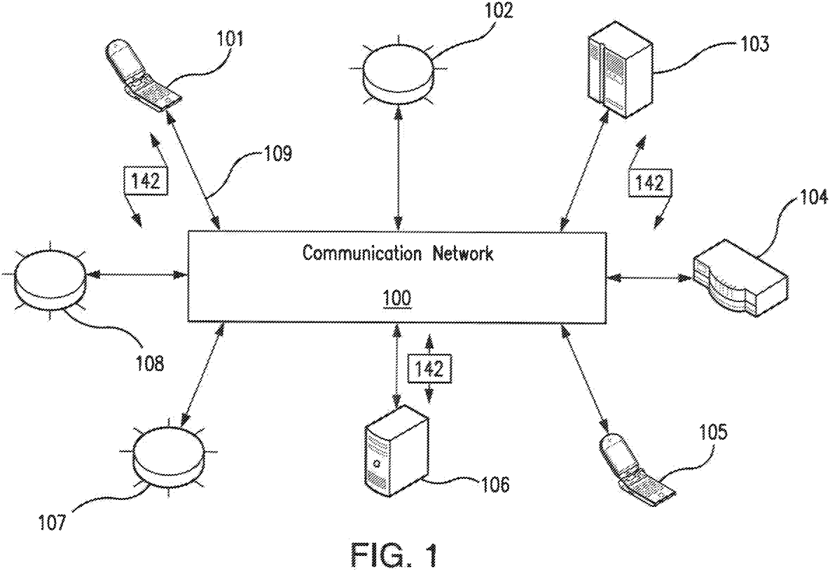

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

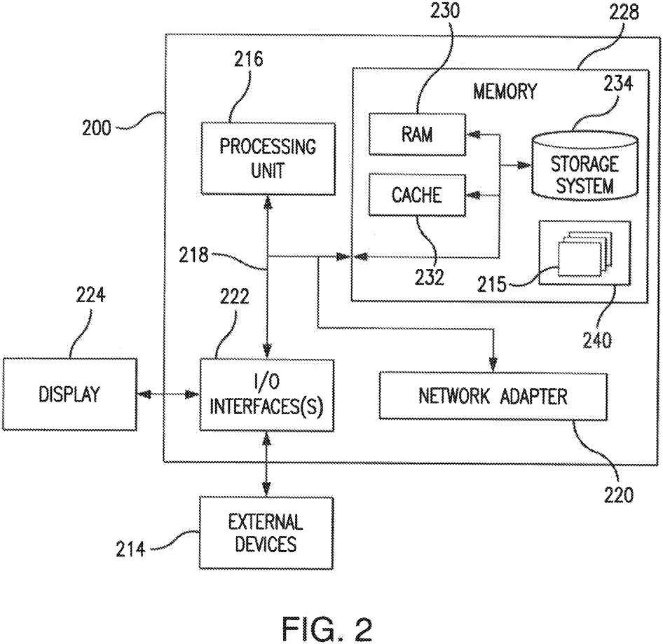

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the present disclosure (e.g., a server 1-6 configured and operable to provide a golf course iterative rating application). Device 200 is only one example of a suitable system and is not intended to suggest any limitation as to the scope of use or functionality of embodiments of the disclosure described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the disclosure.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of embodiments of the disclosure as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which embodiments of the below described present disclosure may be implemented. FIGS. 1 and 2 are exemplary of a suitable environment and are not intended to suggest any limitation as to the structure, scope of use, or functionality of an embodiment of the present disclosure. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With the exemplary communication network 100 (FIG. 1) and computing device 200 (FIG. 2) being generally shown and discussed above, description of certain illustrated embodiments of the present disclosure will now be provided. As discussed herein, the illustrated embodiments of the present disclosure relate to a golf course computerized automated scoring system and commercial application that utilizes individual golfer score data to construct a dataset of golfers who have submitted scores to both the course being analyzed and other golf courses. For each of the golfer’s in the dataset, it computes an estimate of that golfer’s skill using his scores from other golf courses and an estimate of that golfer’s average score on the course being analyzed. The computerized application preferably uses a Bayesian procedure to update the current estimates of the difficulty ratings for the course being analyzed. The difficulty ratings determine the assumed relationship between golfer skill and expected performance at the course. Preferably, the Bayesian procedure is operable to avoid significant updates to a course’s score ranking absent sufficient of data to justify such a score ranking change. Additionally, the updating procedure may be preferably performed simultaneously for all courses in a given iteration.

It is to be appreciated and understood the described calculations and determinations of the illustrated embodiments are preferably performed on application server 106, whereby the results can be depicted (preferably via UI) on a plurality of user devices (e.g., 101, 103 and 105), as well as generated in a tangible format (e.g., printouts).

The illustrated embodiments preferably include a software application tool executing on server 106, configured and operable to dynamical optimize golf course and slope ratings using GHIN data. The Golf Handicap Information Network (GHIN) is a service offered by the USGA to golf associations worldwide. USGA GHIN is a handicapping computational service provided by the USGA through authorized associations and clubs. A golfer typically belongs to a golf club to obtain a USGA Handicap Index after which they will get a GHIN Number.

In accordance with an illustrated embodiment, the application server 106 is configured and operable to analyze a dataset of GHIN scores to simultaneously optimize course and slope ratings for each course present in the dataset. Thus, instead of simply comparing course A to course B, this method of the illustrated embodiment analyzes course A by looking at scores from golfers who have also played at a plurality of other courses, to automatically adjust course A’s ratings if they are inconsistent with the information provided by a dataset representative of other courses. It is to be appreciated and understood however that the application server 106 is configured and operable such that it does not determine (e.g., calculate) a given course’s ratings entirely from the data as this may be disingenuous and potentially unstable for golf courses not having a sufficient amount of associated scores in the GHIN. Rather, the application server 106 is configured and operable to effectively combine data/information from both a golf course’s assigned ratings and the GHIN data. This ensures that the current ratings are taken into account, and the method of the application server 106 is an effective computer tool for optimizing golf course ratings over time.

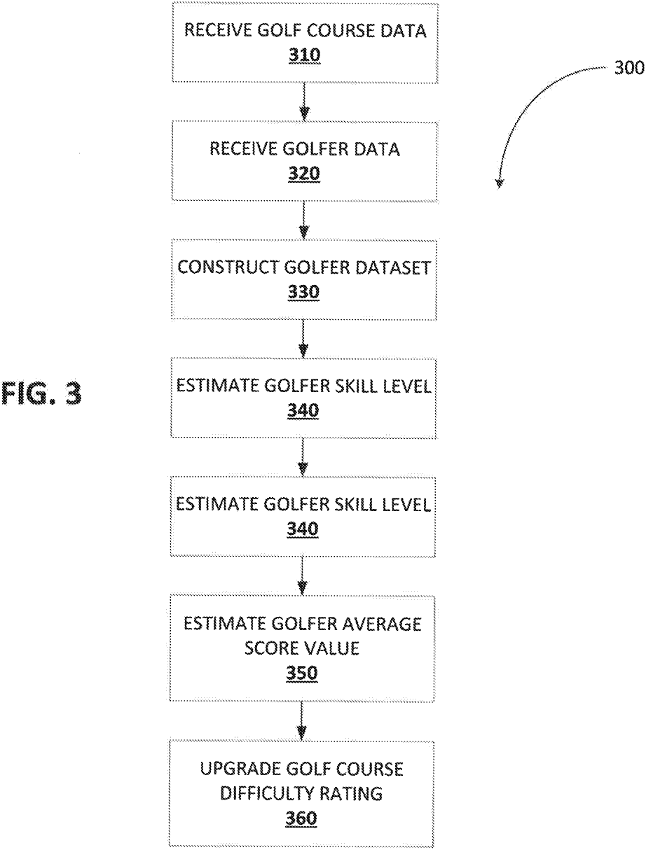

With reference now to FIG. 3, shown is a flow chart demonstrating an exemplary implementation of a method of operation 300 for application server 106 in accordance with the illustrated embodiments of the present disclosure for dynamically determining an updated difficulty rating for one or more golf courses. It is noted that the order of steps shown in FIG. 3 is not required, so in principle, the various steps may be performed out of the illustrated order. Also certain steps may be skipped, different steps may be added or substituted, or selected steps or groups of steps may be performed in a separate application following the embodiments described herein.

Starting at step 310, data is received relating to an initially assigned value indicative of a difficulty rating for a golf course to be evaluated (e.g., golf course A - as mentioned above, this data was manually determined using prior art methods). Next, at step 320, data is received from a plurality of golfer’s (e.g., GHIN data) indicative of their respective scoring values associated with playing on a plurality of golf courses (e.g., golf courses A, B, C, D and E). After the aforesaid data is received, a dataset of golfers is constructed utilizing the received data from the plurality of golfers, wherein a golfer is included in the dataset dependent upon having at least one submitted score value associated with the golf course to be evaluated (e.g., golf course A), step 330. Next, a skill value is estimated for each golfer in the dataset preferably by utilizing each golfer’s scoring values from golf courses other than the golf course (e.g., golf courses B, C, D and E) currently being evaluated (e.g., golf course A), step 340. At step 350, an estimated average score value relative to the golf course to be evaluated (e.g., golf course A) is then determined for each golfer in the dataset. And at step 360, the updated difficulty rating is determined for the golf course to be evaluated (e.g., golf course A) based upon the estimated skill value (step 340) and estimated average score value (step 350) for each golfer in the dataset. Preferably, in accordance with certain illustrated embodiments of the present disclosure, this determination includes analyzing the estimated skill value and estimated average score value for each golfer in the dataset utilizing a Bayesian algorithmic technique. Additionally, in accordance with certain illustrated embodiments of the present disclosure a difficulty rating relative to a plurality of golf courses is determined simultaneously via an iterative process.

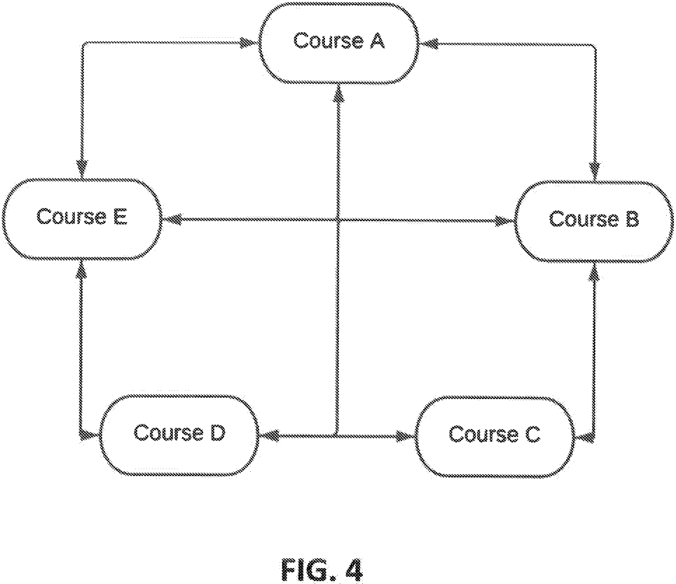

For instance, such an exemplary scenario utilizing the method of operation 300 of FIG. 3 is now described with reference to FIG. 4 whereby application server 106 executes an automated computer application in which data relating to a set of golf courses (e.g., A,B,C,D,E) that share golfers (as indicated by the bidirectional arrows connecting each pair) are utilized such that the difficulty of course A, relative to other courses, is analyzed by application server 106 by constructing a skill estimate for golfers who preferably played at course A and at least one other course (e.g., B,C,D,E). Thus, this skill estimate is performed by application server 106 using data from the other courses. For instance, course A’s difficulty ratings are updated by application server 106 according to whether golfers at course A score better or worse than would be predicted based on their performance at all other courses (e.g., B,C,D,E). It is to be appreciated and understood this updating procedure may preferably be performed simultaneously for all courses, pushing all course difficulty estimates towards the true values (under certain mathematical assumptions). It is to be appreciated and understood difficulty estimate updates preferably take into account both the current values and the data, hence they are not static in contrast to the aforementioned prior art methods for ranking golf courses.

Accordingly, exemplary features of the method of operation 300 (FIG. 3) of the application server 106 includes: the ability to be executed as frequently (or infrequently) as desired, and can be iteratively re-run as new score data becomes available; it can be adjusted to weight the human-assigned ratings more or less relative to the information it finds in the score data (e.g., if the importance of the current ratings is adjusted upwards, the method 300 preferably only suggests rating changes for courses where there is sufficient data evidencing that the current ratings are inaccurate); it can rapidly analyze a large set of golf courses, and provides more accurate results with increased relevant data; it mitigates suggesting rating changes for golf courses with few data points (e.g., weak evidence in the data); it does not need to know the actual names of golf courses or any personally identifiable information about golfers, it only needs to be able to uniquely identify them (e.g., eliminates the need for sharing sensitive data with the application server 106); and ease of use as a rating organization securely shares anonymized GHIN score data for a set of clubs by uploading the data to a secure location in cloud storage. It is thus to be appreciated that the application server 106 reads the data, runs its analysis and rating recommendation algorithm for each course that it sees in the dataset, and automatically generates a report outlining its findings.

Thus, it is to be appreciated and understood that certain advantages and features include, that for a selected golf course, information is incorporated both from the assigned difficulty ratings (in its “priors”) and combined with useful information from data generated at a plurality of other golf courses. Thus, this novel computer application takes advantage of the fact that golfers “share information” across many golf courses they play upon. Hence, the performance of a golfer at a certain golf course is not used to estimate his skill at that golf course, which avoids a circularity issue related to how the golfer skill estimate is computed.

A more detailed description of the illustrated embodiments is set forth in Appendix A, the contents of which are incorporated by reference in their entirety.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this disclosure, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer system for dynamically determining an updated difficulty rating for a golf course, comprising:
a memory configured to store instructions;
a processor disposed in communication with the memory, wherein the processor upon execution of the instructions is configured to:
receive data relating to an initially assigned value indicative of a difficulty rating for a golf course to be evaluated;
receive data from a plurality of golfer’s indicative of their respective scoring values associated with playing on a plurality of golf courses;
construct a dataset of golfers, utilizing the received data from the plurality of golfers, wherein a golfer is included in the dataset dependent upon having at least one submitted score value associated with the golf course to be evaluated;
estimate a skill value for each golfer in the dataset utilizing each golfer’s scoring values from golf courses other than the golf course being evaluated; and
estimate, for each golfer in the dataset, an average score value relative to the golf course to be evaluated;
determine the updated difficulty rating for the golf course to be evaluated contingent upon the estimated skill value and estimated average score value for each golfer in the dataset.

2. The computer system as recited in claim 1, wherein determining the updated difficulty rating for the golf course to be evaluated includes analyzing the estimated skill value and estimated average score value for each golfer in the dataset utilizing a Bayesian algorithmic technique.

3. The computer system as recited in claim 2, wherein the determined updated difficulty rating is contingent upon the relationship between a golfer’s estimated skill value and determined expected performance relative to the course to be evaluated.

4. The computer system as recited claim 3, wherein a difficulty rating relative to a plurality of golf courses is determined simultaneously via an iterative process.

5. A non-transitory computer readable storage medium and one or more computer programs embedded therein, the computer programs comprising instructions, which when executed by a computer system, cause the computer system to:
receive data relating to an initially assigned value indicative of a difficulty rating for a golf course to be evaluated;
receive data from a plurality of golfer’s indicative of their respective scoring values associated with playing on a plurality of golf courses;
construct a dataset of golfers, utilizing the received data from the plurality of golfers, wherein a golfer is included in the dataset dependent upon having at least one submitted score value associated with the golf course to be evaluated;
estimate a skill value for each golfer in the dataset utilizing each golfer’s scoring values from golf courses other than the golf course being evaluated; and
estimate, for each golfer in the dataset, an average score value relative to the golf course to be evaluated;
determine the updated difficulty rating for the golf course to be evaluated contingent upon the estimated skill value and estimated average score value for each golfer in the dataset.

6. The non-transitory computer readable storage medium as recited in claim 5, wherein determining the updated difficulty rating for the golf course to be evaluated includes analyzing the estimated skill value and estimated average score value for each golfer in the dataset utilizing a Bayesian algorithmic technique.

7. The non-transitory computer readable storage medium as recited in claim 6, wherein the determined updated difficulty rating is contingent upon the relationship between a golfer’s estimated skill value and determined expected performance relative to the course to be evaluated.

8. The non-transitory computer readable storage medium as recited claim 7, wherein a difficulty rating relative to a plurality of golf courses is determined simultaneously via an iterative process.

9. A computer method for dynamically determining an updated difficulty rating for a golf course, comprising:
receiving data, in a computer processor, relating to an initially assigned value indicative of a difficulty rating for a golf course to be evaluated;
receiving data, in the computer processor, from a plurality of golfer’s indicative of their respective scoring values associated with playing on a plurality of golf courses;
constructing, by the computer processor, a dataset of golfers, utilizing the received data from the plurality of golfers, wherein a golfer is included in the dataset dependent upon having at least one submitted score value associated with the golf course to be evaluated;
estimating, by the computer processor, a skill value for each golfer in the dataset utilizing each golfer’s scoring values from golf courses other than the golf course being evaluated; and
estimating, by the computer processor, for each golfer in the dataset, an average score value relative to the golf course to be evaluated;
determining, by the computer processor, the updated difficulty rating for the golf course to be evaluated contingent upon the estimated skill value and estimated average score value for each golfer in the dataset.

10. The computer method as recited in claim 9, wherein determining the updated difficulty rating for the golf course to be evaluated includes analyzing the estimated skill value and estimated average score value for each golfer in the dataset utilizing a Bayesian algorithmic technique.

11. The computer method as recited in claim 10, wherein the determined updated difficulty rating is contingent upon the relationship between a golfer’s estimated skill value and determined expected performance relative to the course to be evaluated.

12. The computer method as recited claim 11, wherein a difficulty rating relative to a plurality of golf courses is determined simultaneously via an iterative process.
